(19) United States
(12) Patent Application Publication
(10) Pub. No.: US 2004/0205753 A1
(43) Pub. Date: Oct. 14, 2004

(54) Timing ring mechanism

(75) Inventor: Mark Justin Moore, Cambridge (GB)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: Globespan Virata Inc., Red bank, NJ

(21) Appl. No.: 10/642,336

(22) Filed: Aug. 18, 2003

Related U.S. Application Data
(60) Provisional application No. 60/403,656, filed on Aug. 16, 2002.

(51) Int. Cl. G06F 9/46

(52) U.S. Cl. 718/100

(57) ABSTRACT

A method and system for scheduling threads and timer mechanisms of events in a computer system that includes a central processing unit (CPU), a plurality of input/output (I/O) devices, such devices as storage devices, network interface devices (NIDs) and a memory which is typically used to store various applications or other instructions which, when invoked enable the CPU to perform various tasks the timer structure provides a ring structure and an associated control block is provided. The timer mechanism of the present invention comprises a ring structure that includes an array of ring slots, with the slots relating to pointers for implementing a circular array of LIFO (Last In, First Out) queues generally where each LIFO queue maintains a listing of EventDescriptors that relate to functions which must be performed during the time slot associated with the particular pointer position.

### CROSS REFERENCE TO RELATED APPLICATIONS

Priority is claimed based on U.S. Provisional Application No. 60/403,656 entitled “Timing Ring Mechanism” filed Aug. 16, 2002.

### FIELD OF THE INVENTION

The present invention relates generally to the field of computer systems and, more particularly, to systems and methods for scheduling timing and executions in operating systems for such computer systems.

### BACKGROUND OF THE INVENTION

The operation of modern computer systems is typically governed by an operating system (OS) software program which essentially acts as an interface between the system resources and hardware and the various applications which make requirements of these resources. Easily recognizable examples of such programs include Microsoft Windows™, UNIX, DOS, VxWorks, and Linux, although numerous additional operating systems have been developed for meeting the specific demands and requirements of various products and devices. In general, operating systems perform the basic tasks which enable software applications to utilize hardware or software resources, such as managing I/O devices, keeping track of files and directories in system memory, and managing the resources which must be shared between the various applications running on the system. Operating systems also generally attempt to ensure that different applications running at the same time do not interfere with each other and that the system is secure from unauthorized use.

In conventional data processing systems, a processor operates to execute a sequence of instructions, the result of which accomplishes the tasks set before it. Unfortunately, simple sequential execution of instructions is not always possible or advantageous in systems which must be responsive to external events or errors, such as a network device which receives and transmits signals on a plurality of network ports. In certain circumstances, it is desirable to interrupt the execution of a current activity to handle a request or respond to an unexpected event. These disruptions in processor activity are commonly referred to as interrupts and exceptions.

As an example, a processor may receive an interrupt request (IRQ) from an external device. In response, the processor saves information relating to the current state of the machine, including an indication of the address of the next instruction to be executed, and then immediately transfers control to an interrupt handler which begins at some predetermined address. As another example, if an execution error such as divide-by-zero or general page fault occurs during the execution of a particular instruction, the processor may similarly save information related to the current state of the machine and transfer control to an exception handler.

It should be understood that, although the terms ‘exception’ and ‘interrupt’ have been used above to describe different circumstance or events, each may be treated in a similar manner by the processor. Generally speaking, an exception refers to any instruction that operates to disrupt ordinary program execution, such as an interrupt request (IRQ) or a system error. The term ‘exception’ typically refers to internal instructions in response to unexpected events or errors (e.g., divide by zero errors, general protection faults, etc.), while the term ‘interrupt’, typically refers to a specific kind of exception relating to requests for access to processor resources by external devices (e.g., a PCI card, a keyboard controller, etc.). Therefore, although distinctions may exist between the different types of ‘exceptions’, as used herein, the terms interrupt and exception are used interchangeably.

Each type of exception recognized by the processor has associated therewith a unique vector number. Further, each recognized exception also has associated therewith an exception service routine (commonly referred to as an exception handler) saved at a particular location within the system's memory. The exception handler routine includes the code necessary for the processor to ‘handle’ the exception. Upon receipt of an interrupt or exception, the processor saves information relating to the current state of the machine onto a system stack. This enables the processor to properly return to the current activity following execution of the appropriate exception service routine. The processor then vectors to the memory location of the appropriate exception handler and executes the code contained therein. Once the exception has been “handled”, the processor retrieves the saved current state information from the system stack and resumes operation of the original program. Several techniques are known for identifying the entry point for each exception handler.

In one technique, a table of addresses is created, typically starting at a memory address of 0 within the system's memory and commonly referred to as an exception vector table. Each entry in the exception vector table is the same length as the length of an memory location address (e.g., two or four bytes) and contains the entry point for a corresponding vector number. When an interrupt or exception occurs, the processor first determines the base address of the table, then adds m times the vector number (where m is the number of bytes in each entry). The processor then loads the information stored at the resulting address into the program counter (PC) enabling transfer of control to the associated exception handler routine beginning at the address specified in the table entry. The program counter is a register in the processor that contains the address of the next instruction to be executed.

In other systems, an entire branch instruction is stored in each entry in the exception vector table, instead of merely the address of a handler. The number of bytes in each entry is equal to the number of bytes in a branch instruction. When an interrupt or exception is received, the processor, as above, determines the table base address, adds m times the vector number, and loads the result into the PC. Since this result includes the branch instruction itself, this instruction is executed and control is finally transferred to the appropriate exception handler following execution of the branch instruction.

Further, provisions have been made for circumstances in which two or more exceptions occur at the same time. Conventionally, a priority system is used to determine the order in which the exceptions are handled. When the processor executes an exception handler, all exceptions having the same or lower priority are disabled until the handler has finished. This means that even an exception handler can be interrupted by an exception having a higher priority level. The processor can also disable interrupts during crucial parts in a program, thus ensuring that the current activity is completed in sequence.

Depending upon the requirements of the system in which they are installed, operating systems can take several forms. For example, a multi-user operating system allows two or more users to run programs at the same time. A multiprocessing operating systems supports running a single application across multiple hardware processors (CPUs). A multitasking operating system enables more than one application to run concurrently on the operating system without interference. A multithreading operating system enables different parts of a single application to run concurrently. Real time operating systems (RTOS) execute tasks in a predictable, deterministic period of time. Most modern operating systems attempt to fulfill several of these roles simultaneously, with varying degrees of success.

In order to accurately manage requests for system resources, operating systems must carefully schedule the execution of any potential application. Unfortunately, conventional timing and scheduling mechanisms fail to provide accurate methods for accomplishing this goal. Accordingly, there is a need in the art of computer systems for a system and method for providing timing in computer operating systems.

### SUMMARY OF THE INVENTION

The present invention overcomes the problems noted above, and realizes additional advantages, by providing for methods and systems for scheduling threads and timer mechanisms of events in a computer system that includes a central processing unit (CPU), a plurality of input/output (I/O) devices, and a memory. Included in the plurality of I/O devices are such devices as a storage device, and a network interface device (NID). The memory is typically used to store various applications or other instructions which, when invoked enable the CPU to perform various tasks. Among the applications stored in memory are an operating system which executes on the CPU and includes the thread scheduling application of the present invention. Additionally, the memory also includes various real-time programs as well as non-real-time programs which together share all the resources of the CPU.

In accordance with the present invention, the threads scheduling and timer mechanisms system provides a method for implementing a software timer mechanism. The inventive software timer mechanism permits micro-second level timing accuracy to be generated with very low software overheads. Further, the timer of the present invention permits aggregation of events to improve software performance. One example of suitably aggregated events are hardware interrupts which may place undue overhead on system processors during rapid occurrences.

In accordance with one embodiment of the present invention, an algorithm may be used that triggers a monostable software timer to gate the interrupt enables batching the servicing of interrupt requests such as from the delivery of network data. This avoids pathological scenarios where interrupt timing results in excessive CPU overhead in hand ling entry and exit to the interrupt code. The timer code may be resident either on the host processor or on a soft co-processor and provides a thousand fold increase in the software timer resolution compared to conventional systems.

Another embodiment of the present invention of the timer structure provides a ring structure and an associated control block is provided. The ring structure includes an array of ring slots, with the slots relating to pointers for implementing a circular array of LIFO queues generally referred to by the numeral. Each LIFO queue maintains a listing of EventDescriptors which relate to functions which must be performed during the time slot associated with the particular pointer position. In the illustrated embodiment, the LIFO queue includes multiple generic timer events which invoke handler functions using arguments included in the queue to perform a requested action. By providing such timing in accordance with the present invention, timing precision is reduced from a 10 micro-second level to a 100 microsecond level.

In accordance with another embodiment of the present invention, the timing ring wraps after a finite time, fixed by the number of entries and the time period associated with an entry. After proceeding through each entry, the ring starts at the beginning again. Time intervals greater than this wrap interval can be achieved in one of two ways. Initially, a single timing ring with sufficient resolution is used and a multiplier is implemented that breaks the requested delay in to (n* total_ring_period+fractional_ring_period). The request is then queued at the point dictated by the fractional period and a counter set to ‘n’. On each pass of the ring, the counter is decremented. If after being decremented the result is negative, the event is triggered.

In an additional embodiment, the present invention further provides a number of ring structures running in parallel with each other. Most systems use only a single ring, however you could use several with different timer periods to improve efficiency if there is a need for a small amount of high-precision (short period) event handling coupled with a need for a large amount of low-precision (longer period) traffic. Regarding the time intervals greater than that of a single ring, multiple rings may be used having different periods, such that the resolution (ie accuracy) of the delay increases with the delay period. Most long period timing events need correspondingly lower resolution, but high resolution long period delays can be constructed by factoring the total delay in to progressively smaller components. The event is initially queued on the longest period ring, after which it ‘cascades’ down to progressively shorter period/higher resolution rings until the precise delay has been satisfied.

### BRIEF DESCRIPTION OF THE DRAWINGS

The present invention can be understood more completely by reading the following

Detailed Description of the Preferred Embodiments, in conjunction with the accompanying drawings.

FIG. 1 is a high-level block diagram illustrating a computer system for use with the present invention.

FIG. 2 is a block diagram illustrating the timing ring according to an embodiment of the present invention.

FIG. 3 is a block diagram illustrating an event descriptor queue structure according to an embodiment of the present invention.

### DETAILED DESCRIPTION OF THE INVENTION

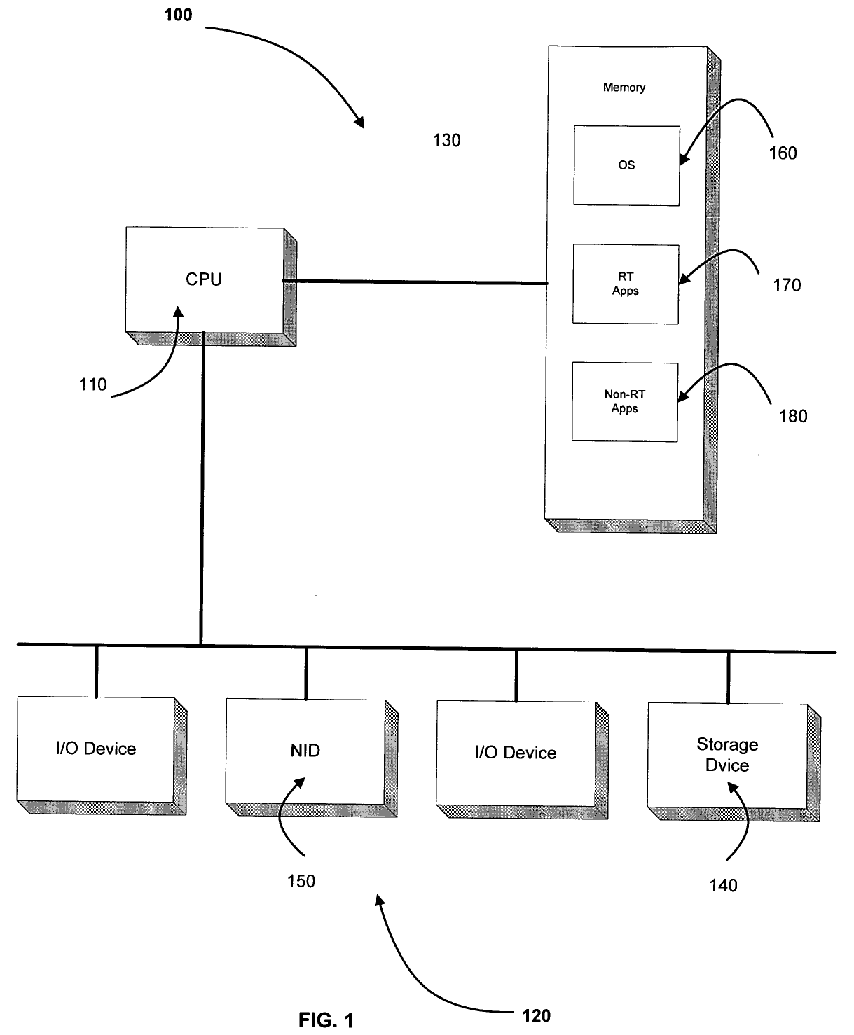

Referring now to the Figures and, in particular, to FIG. 1, there is shown a high-level block diagram illustrating a computer system 100 for use with the present invention. In particular, computer system 100 includes a central processing unit (CPU) 110, a plurality of input/output (I/O) devices 120, and memory 130. Included in the plurality of I/O devices are such devices as a storage device 140, and a network interface device (NID) 150. Memory 130 is typically used to store various applications or other instructions which, when invoked enable the CPU to perform various tasks. Among the applications stored in memory 130 are an operating system 160 which executes on the CPU and includes the thread scheduling application of the present invention. Additionally, memory 130 also includes various real-time programs 170 as well as non-real-time programs 180 which together share all the resources of the CPU.

In accordance with the present invention, system 100 is provided with a system and method for implementing a software timer mechanism. The inventive software timer mechanism permits micro-second level timing accuracy to be generated with very low software overheads. Further, the timer of the present invention permits aggregation of events to improve software performance. One example of suitably aggregated events are hardware interrupts which may place undue overhead on system processors during rapid occurrences.

In accordance with one embodiment of the present invention, an algorithm may be used that triggers a monostable software timer to gate the interrupt enables batching the servicing of interrupt requests such as from the delivery of network data. This avoids pathological scenarios where interrupt timing results in excessive CPU overhead in hand ling entry and exit to the interrupt code. The timer code may be resident either on the host processor or on a soft co-processor and provides a thousand fold increase in the software timer resolution compared to conventional systems.

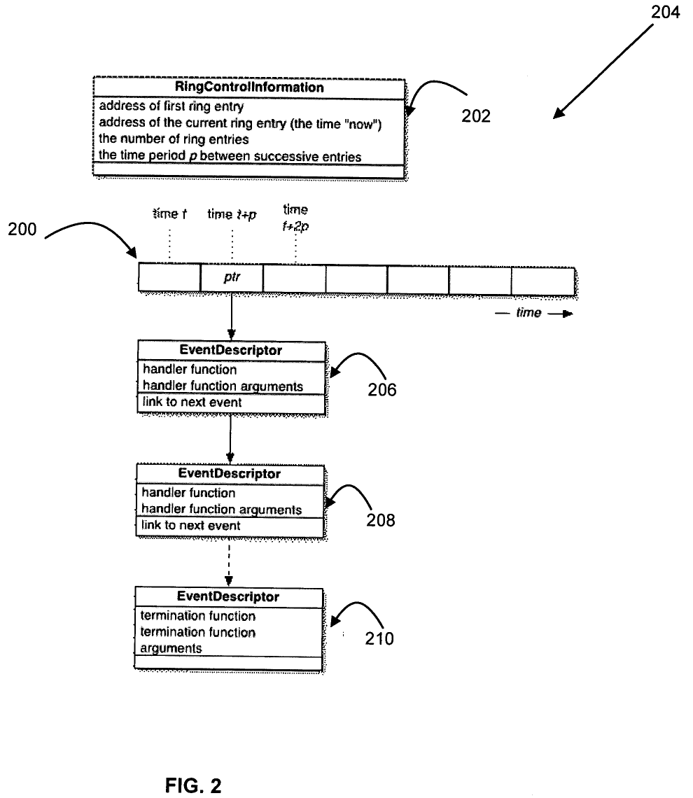

Referring now to FIG. 2, there is shown a block diagram illustrating one embodiment of the timer structure of the present invention. In particular, a ring structure 200 and an associated control block 202 is provided. The ring structure 200 includes an array of ring slots, with the slots relating to pointers for implementing a circular array of LIFO queues generally referred to by the numeral 204. Each LIFO queue maintains a listing of EventDescriptors which relate to functions which must be performed during the time slot associated with the particular pointer position. In the illustrated embodiment, the LIFO queue includes two generic timer events 206 and 208 which invoke handler functions using arguments included in the queue to perform a requested action. The last illustrated instance of an event handler 210 includes a terminating function which provides for termination of the various processing for the given time slot. By providing timing in accordance with the present invention, timing precision is reduced from a 10 micro-second level to a 100 microsecond level.

A terminator event (e.g., 210) breaks the event processing chain and performs any activity necessary to prepare for the processing of the next timer slot. If the implementation is in software using a repeating fixed period hardware timer, the termination function may simply advance the ‘current time’ reference and return from interrupt. Additionally, the terminator event for the ring entry with the highest address is unique in that the next timer slot to be processed will be the first slot in the ring, rather than the next one. This avoids the need for conditional code to check for ring pointer ‘wrap-around’ on each and every ring entry.

The control block 202 contains an address corresponding to the first ring entry 206, an address corresponding to the ‘current’ ring entry 208, a entry relating to the total number of ring entries, (i.e., the total number of time slots on the ring) 210, and an entry relating to the time period between adjacent ring entries. By providing this information in a control block, basic operations for queuing can be efficiently implemented.

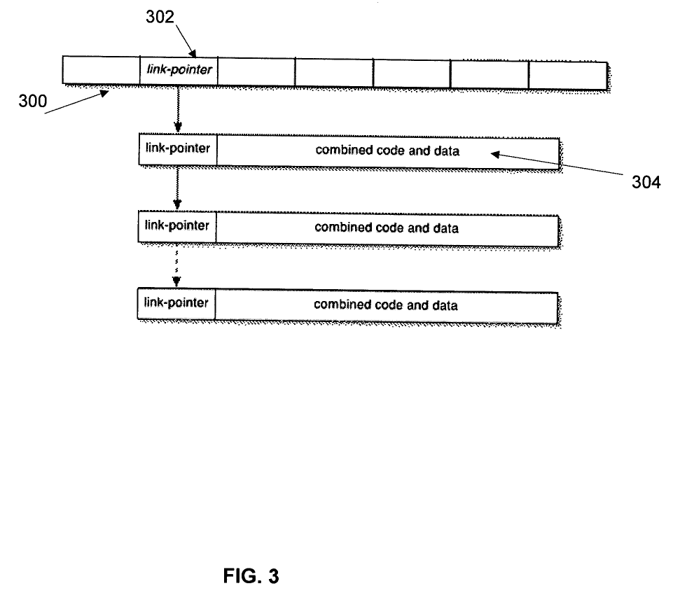

Referring now to FIG. 3, there is shown a block diagram, schematically illustrating one embodiment of an example event descriptor implementation. In the present embodiment, each time slot 300 in the timing ring maintains a single pointer field 302 used to construct LIFO (last in first out) queues of descriptors on the ring, combined with event-specific code and data, one of which is shown at element 304. The timing system makes no assumptions about the purpose of the event handling code and data. Therefore, the established mechanism it may be used for any purpose that requires precision timing.

All events are dynamic and are added and removed as required for the purposes of the application using a simple linked list structure. At any given time, one specific point on the ring is designated the ‘current time’. The offset relative to this at which the entry is queued determines the period of delay that is applied. Further, there is always at least one event queued on each ring point, which is always the last item queued (by using a LIFO structure). Queues are singly linked lists which both ensures LIFO ordering that preserves the presence of the terminating event, while also providing the minimum possible overhead in performing a queue operation.

It should be understood that while no specific purpose is dedicated to the use of timer events, the design of the ring system and structures is intended to support very simple operations that are typically repeated frequently and with high timing precision. Typically, the code implementing a given event will therefore be written in tightly optimized assembler. More complex processing may be achieved, for example, by sending a message to a higher level application program running on the system.

In accordance with another embodiment of the present invention, the timing ring wraps after a finite time, fixed by the number of entries and the time period associated with an entry. After proceeding through each entry, the ring starts at the beginning again. Time intervals greater than this wrap interval can be achieved in one of two ways. Initially, a single timing ring with sufficient resolution is used and a multiplier is implemented that breaks the requested delay in to (n* total_ring_period+fractional_ring_period). The request is then queued at the point dictated by the fractional period and a counter set to ‘n’. On each pass of the ring, the counter is decremented. If after being decremented the result is negative, the event is triggered. A second method for providing greater time intervals includes the use of multiple rings and is discussed in detail below.

In further accordance with the present invention, any number of ring structures may be provided running in parallel with each other. Most systems use only a single ring, however you could use several with different timer periods to improve efficiency if there a need for a small amount of high-precision (short period) event handling coupled with a need for a large amount of low-precision (longer period) traffic.

Regarding the second method of providing time intervals greater than that of a single ring, multiple rings may be used having different periods, such that the resolution (ie accuracy) of the delay increases with the delay period. Most long period timing events need correspondingly lower resolution, but high resolution long period delays can be constructed by factoring the total delay in to progressively smaller components. The event is initially queued on the longest period ring, after which it ‘cascades’ down to progressively shorter period/higher resolution rings until the precise delay has been satisfied.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed:

1. A method of scheduling threads and timer mechanisms of events in a computer system comprising:
implementing a timer mechanism that allows a micro-second level accuracy;
allowing aggregation of said events to improve performance; and
avoiding excessive processor overhead resulting from entry and exit interrupts.

2. The method of claim 1 wherein the timer mechanism is a ring structure with an associated control block.

3. The method of claim 1 wherein implementing the timer mechanism includes triggering a monostable timer to gate interrupt enables to batch servicing of interrupt requests.

4. The method of claim 1 wherein the timer mechanism includes generating an array of ring slots that permits the implementation of a circular array queue.

5. The method of claim 4 wherein the circular array queue is structured as a last in, first out (LIFO) queue.

6. The method of claim 4 including setting a number of timer events in the ring slots that invokes handler functions that include a terminating event function.

7. The method of claim 6, wherein the terminating event for the ring slot with a highest address allows the first slot in the rung to be processed first.

8. The method of claim 2, wherein the control block contains addresses corresponding to a first ring entry, a total number of entries, and an entry for a time period between adjacent ring entries for queuing basic operations.

9. A computer-readable medium having computer-executable instructions for performing a method comprising:
implementing a timer mechanism that allows a micro-second level accuracy;
allowing aggregation of said events to improve performance; and
avoiding excessive processor overhead resulting from entry and exit interrupts.

10. The computer-readable medium of claim 9 wherein the timer mechanism is a ring structure with an associated control block.

11. The computer-readable medium of claim 9 wherein implementing the timer mechanism includes triggering a monostable timer to gate interrupt enables to batch servicing of interrupt requests.

12. The computer-readable medium of claim 9 wherein the timer mechanism includes generating an array of ring slots that permits the implementation of a circular array queue.

13. The computer-readable medium of claim 12 wherein the circular array queue is structured as a last in, first out (LIFO) queue.

14. The computer-readable medium of claim 12 including setting a number of timer events in the ring slots that invokes handler functions that include a terminating event function.

15. The computer-readable medium of claim 14, wherein the terminating event for the ring slot with a highest address allows the first slot in the rung to be processed first.

16. The computer-readable medium of claim 10, wherein the control block contains addresses corresponding to a first ring entry, a total number of entries, and an entry for a time period between adjacent ring entries for queuing basic operations.
